(19) United States
(12) Patent Application Publication
(10) Pub. No.: US 2020/0265419 A1
(43) Pub. Date: Aug. 20, 2020

(54) System for Issuing and Converting Virtual Currency in Physical Voucher Manner and Method Thereof

(71) Applicant: M-ONE INC., Apia (WS)

(72) Inventor: Juan-Hung Wu, Taipei (TW)

(21) Appl. No.: 16/868,630

(22) Filed: May 7, 2020

Related U.S. Application Data
(63) Continuation-in-part of application No. 16/115,197, filed on Aug. 28, 2018.

(51) Int. Cl. G06Q 20/36; G06Q 20/04; G06Q 20/32; G06Q 20/38

(52) U.S. Cl. CPC G06Q 20/3672; G06Q 20/045; G06Q 20/3821; G06Q 20/3276; G06Q 20/3674

(57) ABSTRACT

A system for issuing and converting virtual currency in a physical voucher manner and a method thereof are provided. The system comprises a host server, a mobile device, and an application integration system connected to the host server and the mobile device. The host server comprises a first storage unit including a first database for storing a plurality of pieces of virtual currency data. The mobile device is configured to receive an authentication code from a user. The application integration system comprises a second storage unit including a second database for storing a plurality of pieces of comparison data and is configured to receive the authentication code from the mobile device, and to generate a coincident signal after analytically comparing the authentication code with the pieces of comparison data. The coincident signal is further transmitted to the host server for further analytical comparison with the pieces of virtual currency data.

### CROSS REFERENCE TO RELATED APPLICATIONS

The present application is a Continuation-In-Part Application of U.S. patent application Ser. No. 16/115,197 filed on Aug. 28, 2018, the contents of which are incorporated herein by reference in their entirety.

### BACKGROUND OF THE INVENTION

### 1. Technical Field

The present invention relates to a system for issuing and converting virtual currency in a physical voucher manner and a method thereof, and in particular, to a system for issuing and converting virtual currency in a physical voucher manner capable of materializing virtual currency and having high security, and a method thereof.

### 2. Background

After consumption, directly making payment in cash by a consumer is always an intuitive payment behavior of people. However, with progress of the times and science and technology, various transaction payment manners, such as a debit card, a credit card, an electronic wallet, and virtual currency, appear, so that people may hold less virtual currency in an existing transaction amount. Moreover, after a quantity of intelligent mobile apparatuses (mobile devices) tends to be greatly increased, intelligent mobile apparatuses have become indispensible tools in life of most people at present, storing credit card information to a mobile apparatus or using an electronic wallet on a mobile device to make payment for consumption can avoid carrying a large quantity of physical articles such as a credit card and cash, thereby indeed reducing cash withdrawal costs and increasing convenience in life.

Recently, transaction payment manners of virtual currency, such as BitCoin, Litecoin, and Ripple, begin to appear, and the virtual currency refers to a currency system in which cash transactions are replaced with a digital accounting manner. The virtual currency effectively improves efficiency and security of transactions. For example, a consumer does not need to carry a large amount of cash, meanwhile, a business does not need human power to count cash, and a transaction process is mainly completed by means of a financial institution or a P2P system. However, transaction platforms of the virtual currency are quite fragile. Moreover, a transaction platform is usually a website, and the website may be attacked by a hacker, and consequently, has low security. In addition, because virtual currency is virtualized currency instead of physical currency, and therefore, is out of reach of mass consumers. Therefore, how to resolve the foregoing conventional problems and disadvantages is a direction in which the inventor of the present invention and relevant manufacturers in this industry urgently want to conduct researches and make improvements.

### SUMMARY

In view of the above, to effectively resolve the foregoing problems, a primary objective of the present invention is to provide a system for issuing and converting virtual currency in a physical voucher manner capable of materializing virtual currency.

A secondary objective of the present invention is to provide a system for issuing and converting virtual currency in a physical voucher manner capable of greatly increasing commercial activity.

A secondary objective of the present invention is to provide a system for issuing and converting virtual currency in a physical voucher manner having high security.

A secondary objective of the present invention is to provide a system for issuing and converting virtual currency in a physical voucher manner having a two-step authentication effect.

A secondary objective of the present invention is to provide a method for issuing and converting virtual currency in a physical voucher manner capable of materializing virtual currency.

A secondary objective of the present invention is to provide a method for issuing and converting virtual currency in a physical voucher manner capable of greatly increasing commercial activity.

A secondary objective of the present invention is to provide a method for issuing and converting virtual currency in a physical voucher manner having high security.

A secondary objective of the present invention is to provide a method for issuing and converting virtual currency in a physical voucher manner having a two-step authentication effect.

To achieve the foregoing objectives, the present invention provides a system for issuing and converting virtual currency in a physical voucher manner, including: a host server, a mobile device, and an application integration system, wherein the host sever comprises a first storage unit, wherein the first storage unit comprises a first database for storing a plurality of pieces of virtual currency data; the mobile device is configured to receive an authentication code input by a user; and the application integration system is connected to the host server and the mobile device, wherein the application integration system comprises a second storage unit, the second storage unit comprises a second database for storing a plurality of pieces of comparison data, the application integration system is configured to receive the authentication code transmitted from the mobile device, and to generate a coincident signal after analytically comparing the authentication code with the pieces of comparison data, and then the coincident signal is further transmitted to the host server, and is analytically compared with the pieces of virtual currency data.

To achieve the foregoing objectives, the present invention provides a method for issuing and converting virtual currency in a physical voucher manner, applied to a system, wherein the system comprises a host server, a mobile device, and an application integration system, the application integration system is connected to the host server and the mobile device, and the method comprises: storing, by the host server, a plurality of pieces of virtual currency data; receiving, by the mobile device, an authentication code input by a user; and storing, by the application integration system, a plurality of pieces of comparison data, receiving the authentication code transmitted from the mobile device, and after analytically comparing the authentication code with the pieces of comparison data, generating a coincident signal. Then, the coincident signal is further transmitted to the host server, and is analytically compared with the pieces of virtual currency data.

By means of the system and method of the present invention, virtual currency (such as BitCoin, Litecoin, and Ripple) currently circulated in the market can be converted into a materialized valuable voucher, and can be massively issued and printed in cooperation with activities of various industries, thereby greatly improving commercial activity. In addition, the system and method of the present invention further have a two-step authentication effect, thereby effectively achieving high security of the valuable voucher.

### BRIEF DESCRIPTION OF THE DRAWINGS

FIG. 1 is a schematic block diagram of a system according to a preferred embodiment of the present invention;

FIG. 2 is a schematic diagram of a virtual currency unit according to the present invention;

FIG. 3 is a schematic block diagram of a system according to another embodiment of the present invention;

FIG. 4 is a schematic block diagram of a system according to still another embodiment of the present invention; and

FIG. 5 is a flowchart of steps of a method according to the present invention;

FIG. 6 is a flowchart for verifying virtual currency physical vouchers.

### DETAILED DESCRIPTION

The foregoing objectives of the present invention and structural and functional features of the present invention are described based on preferred embodiments of the accompanying drawings.

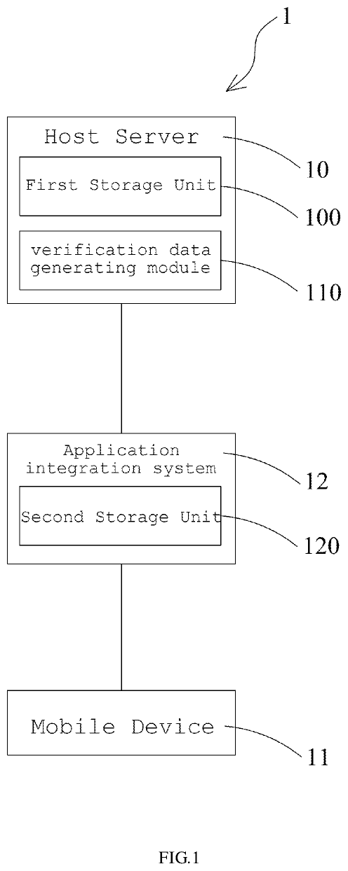

FIG. 1 is a schematic block diagram for issuing and converting virtual currency in a physical voucher manner according to the present invention. Referring to FIG. 1, as shown in the figure, a system 1 for issuing and converting virtual currency in a physical voucher manner comprises a host server 10, a mobile device 11, and an application integration system 12. The host server 10 comprises a first storage unit 100 and a verification data generating module. The first storage unit 100 comprises a first database and stores a plurality of pieces of virtual currency data. The virtual currency data comprises data such as a virtual currency card number, a virtual currency issuance date, or an amount of virtual currency. It should be specially noted that the host server 10 is a host server 10 having functions such as performing management, value storage, binding, and cancellation on the pieces of virtual currency data. The verification data generating module 110 generates a pair of public key and private key with a specific encryption algorithm. The private key is transmitted to the second storage unit 120 of the application integration system 12.

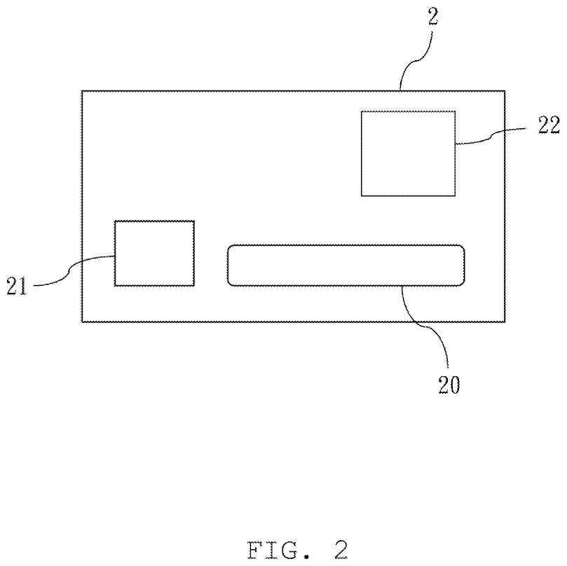

FIG. 2 is a schematic diagram of a virtual currency unit according to the present invention. Referring to FIG. 2, the virtual currency unit 2 is a physical valuable voucher, which can have an appearance structure that is made of a material such as paper (for example, a paper money form) or plastics (for example, a credit card form), and can be massively issued and printed. There is an authentication area 20 and an encryption area 21 on the virtual currency unit 2, and an authentication code is generated on the authentication area 20. It should be particularly noted that authentication codes of respective virtual currency units 2 are all different from each other, and the authentication code is a random number formed by mixing and combining English letters and numerals. In addition, an anti-see through cover layer is coated over the authentication code, and the anti-see through cover layer is formed over the authentication area 20 by means of a screen printing process. Because the cover layer has a high covering capability and a good confidential effect, and can be easily scraped away (it can be easily scraped away by only using an article such as a coin), a user can obtain an authentication code of the virtual currency unit 2 by scraping away the cover layer. The public key is used for encrypting the virtual currency data so as to generate encrypted data, and generate the authentication code in a hash function for the virtual currency data.

An encryption unit is generated on the encryption area 21. It should be particularly noted that the encryption unit is a two-dimensional barcode. In addition, an encryption unit of the virtual currency unit 2 of the present invention is presented as a QR Code, and QR is an abbreviation of quick response, which means a quick response. The QR code, compared with a common barcode, can store more data, and is a commonly used two-dimensional barcode in the current society. The encryption unit generates an encryption signal.

In addition, a download area 22 is further provided on the virtual currency unit 2. A membership application program code is generated on the download area 22 for a user to scan and then join in the membership. The membership application program code is the same as the encryption unit, and both are presented as two-dimensional barcodes, that is, QR codes.

The mobile device 11 is any one of a smart phone, a tablet computer, and a portable apparatus. The mobile device 11 comprises a camera lens (not shown in the figure). First, a user photographs the membership application program code of the download area 22 with the camera lens. The membership application program code generates a membership specific application program, and the membership specific application program needs to be installed in the mobile device 11. After being installed, the application program is opened, and the application program comprises a membership account field and a membership password field. Further, after the user inputs an account and a password respectively into the membership account field and the membership password field, to join in and log in to the membership, the foregoing authentication code is manually input into the mobile device 11, and then, is transmitted to the application integration system 12.

The application integration system 12 is connected to the host server 10 and the mobile device 11. In this embodiment, a connection manner between the host server 10 and the application integration system 12 is a serial connection by using an application programming interface (API). The application integration system 12 comprises a second storage unit 120. The second storage unit 120 comprises a second database for storing a plurality of pieces of comparison data. The application integration system 12 receives the authentication code transmitted by the mobile device 1 to check and determine whether the virtual currency unit 2 really exists, thereby a first confidential authentication procedure is established.

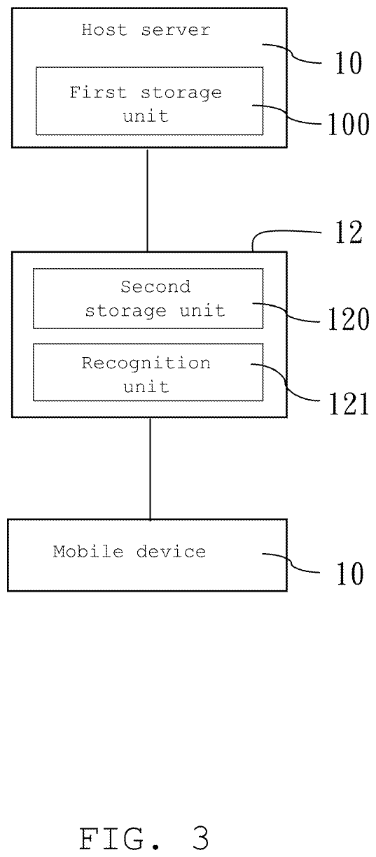

Referring to FIG. 3, in another embodiment, the application integration system 12 further comprises a recognition unit 121, and its objective is that: after the user photographs the encryption unit with the camera lens of the mobile device 11 to obtain an encryption signal, the encryption signal is transmitted to the application integration system 12 and is compared with the comparison data stored in the second database, and after analytical recognition is performed by using the recognition unit 121, whether the virtual currency unit 2 is authentic or fake is further judged, and meanwhile, whether the virtual currency unit 2 has been exchanged (or used) can be judged and determined, thereby a second confidential authentication program is established. In this way, a two-step confidential authentication effect can be achieved.

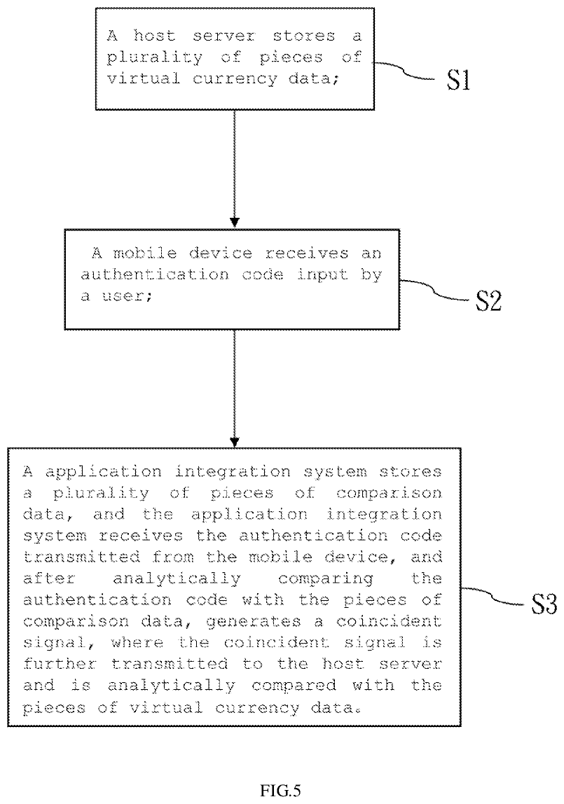

Continuously referring to FIG. 5 together, FIG. 5 is a flowchart of steps of a method used in the present invention. The method is applied to a system 1 of the present invention. The system 1 comprises the foregoing host server 10, mobile device 11, and application integration system 12, and the application integration system 12 is connected to the host server 10 and the mobile device 11. Operation of the present invention is performed by using the method according to the following steps:
S1: The host server 10 stores a plurality of pieces of virtual currency data.
S2: The mobile device 11 receives an authentication code input by a user.
S3: The application integration system 12 stores a plurality of pieces of comparison data, and the application integration system 12 receives the authentication code transmitted from the mobile device 11, and after analytically comparing the authentication code with the pieces of comparison data, generates a coincident signal. Then, the coincident signal is further transmitted to the host server 10 and is analytically compared with the pieces of virtual currency data.

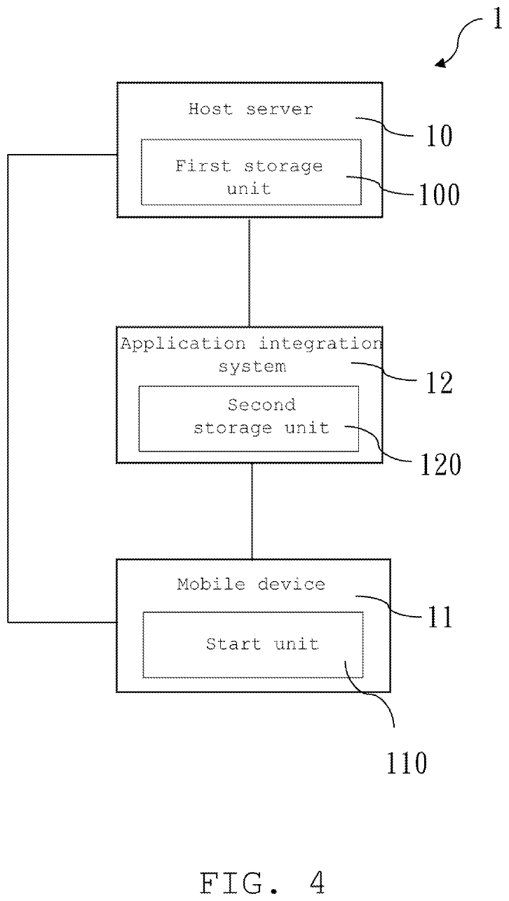

By means of the foregoing steps, when a user wants to deposit an amount in the virtual currency unit 2 to the mobile device 11, the user needs to first install the foregoing application program in the mobile device 11 and log into the program after joining in the membership, and subsequently, inputs the authentication code, wherein the authentication code is analytically compared with the pieces of comparison data, and after being photographed with the camera lens of the mobile device 11, the encryption unit is analytically recognized by using a recognition unit 121 of the application integration system 12, to respectively complete first and second confidential authentication procedures, and after the encryption is verified to be correct, the coincident signal is generated, and the coincident signal is then transmitted to the host server 10 and is analytically compared with the virtual currency data. It should be noted that in this stage, when a piece of virtual currency data in the first storage unit 100 is found by means of analytical comparison with the coincident signal, a start signal is generated, the host server 10 automatically cancel the piece virtual currency data, representing that a card is successfully activated by using the virtual currency unit 2 and is ready to be used. Moreover, the mobile device 11 further comprises a start unit 110 (referring to FIG. 4), the start signal is transmitted to the mobile device 11 to start the start unit 110 to complete a procedure of starting use of the virtual currency unit 2, and an amount of the virtual currency unit 2 is deposited to the mobile device 11, to implement functions by means of which the user can make a transaction or payment by using virtual currency.

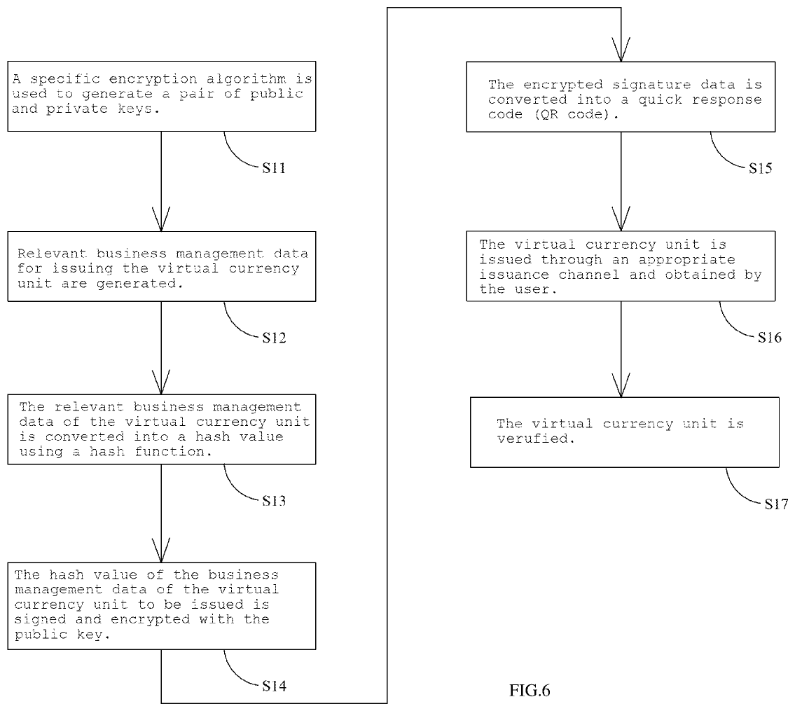

Hereinafter, the verification of the virtual currency physical voucher will be further described. Please refer to FIG. 6, which shows a flowchart of the present invention for verifying virtual currency physical vouchers.

First, in step S11, a specific encryption algorithm is used to generate a pair of public and private keys, such as elliptic curve cryptography (ECC 256) to generate the public and private keys. The private key is stored in the second storage unit 120 of the application integration system 12. Then go to step S12.

In step S12, relevant business management data for issuing the virtual currency unit 2 are generated, such as serial number, issue date, issue version, and denomination. The generated related business management data can be stored in the first storage unit 100 of the host server 10 and the second storage unit 120 of the application integration system 12. Then go to step S13.

In step S13, the relevant business management data of the virtual currency unit 2 is converted into a hash value using a hash function, for example, a cryptographic hash function is used to generate a hash value with collision resistance. The hash function can be a SHA algorithm. The hash table can be stored in the second storage unit 120 of the application integration system 12. Then go to step S14.

In step S14, the hash value of the business management data of the virtual currency unit 2 to be issued is signed and encrypted with the public key. Then go to step S15.

In step S15, the encrypted signature data is converted into a quick response code (QR code), and the converted quick response code is printed on the encryption area 21 on the virtual currency unit 2, and the hash value generated above is printed in the authentication area 20 of the virtual currency unit 2 becomes the authentication code. Then go to step S16

In step S16, the virtual currency unit 2 is issued through an appropriate issuance channel and obtained by the user. Then go to step S17.

In step S17, the user downloads and installs the corresponding application program in the mobile device 11, and scans the authentication code with the mobile device 11 to transmit the authentication code to the application integration system 12. The application integration system 12 receives the authentication code transmitted from the device 11 is used to verify whether the virtual currency unit 2 is correct, and a first confidential authentication procedure is completed; then the user scans the quick response code and sends it to the application integration system 12. The recognition unit 121 of the application integration system 12 decrypts the encrypted signature data of the quick response code with the above private key, it determines whether the virtual currency unit 2 is genuine or counterfeit, and can simultaneously determine and confirm whether the virtual currency unit 2 has been compromised after redemption (or use). Therefore, a second confidential authentication procedure is completed. After the virtual currency unit 2 is verified by two confidential authentication procedures, the denomination and business management data of the virtual currency unit 2 are imported into the user's member account.

Therefore, by means of the system 1 and method of the present invention, virtual currency (such as BitCoin, Litecoin, and Ripple) currently circulated in the market can be converted into a materialized valuable voucher, and can be massively issued and printed in cooperation with activities of various industries, thereby greatly improving commercial activity. In addition, the system 1 and method of the present invention further have a two-step authentication effect, thereby effectively achieving high security of the valuable voucher.

The present invention is described above in detail, but the foregoing is merely a preferred embodiment of the present invention, and cannot limit a scope of implementation of the present invention. Any changes, modifications, and the like made according to the scope claimed by the present invention still all fall within the scope of the patent of the present invention.

### REFERENCE NUMERALS

1 System
10 Host server
100 First storage unit
11 Mobile device
110 Start unit
12 Application integration system 12
120 Second storage unit 120
121 Recognition unit 121
2 Virtual currency unit 2
20 Authentication area 20
21 Encryption area 21
22 Download area 22
S1 Step
S2 Step
S3 Step

What is claimed is:

1. A system for issuing and converting virtual currency in a physical voucher manner, comprising:
a host server, comprising a first storage unit and a verification data generating module, wherein the first storage unit comprises a first database for storing a plurality of pieces of virtual currency data;
a mobile device, configured to receive an authentication code input by a user;
an application integration system, connected to the host server and the mobile device, wherein the application integration system comprises a second storage unit, the second storage unit comprises a second database for storing a plurality of pieces of comparison data, wherein the application integration system is configured to receive an authentication code transmitted from the mobile device, and after analytically comparing the authentication code with the pieces of comparison data, generate a coincident signal, and then the coincident signal is further transmitted to the host server to be analytically compared with the pieces of virtual currency data;
wherein the verification data generating module generates a pair of public key and private key with a specific encryption algorithm and the authentication code in a hash function for the virtual currency data, wherein the private key is transmitted to the second storage unit of the application integration system, and the public key is used for encrypting the virtual currency data so as to generate encrypted data, and generate the authentication code in the hash function for the virtual currency data.

2. The system for issuing and converting virtual currency in a physical voucher manner according to claim 1, wherein the virtual currency data comprises any one of a virtual currency card number, a virtual currency issuance date, and an amount of virtual currency.

3. The system for issuing and converting virtual currency in a physical voucher manner according to claim 1, wherein the authentication code is generated by a virtual currency unit, the virtual currency unit further comprises an authentication area and an encryption area, the authentication area generates the authentication code, and the encryption area generates an encryption unit.

4. The system for issuing and converting virtual currency in a physical voucher manner according to claim 3, wherein the encryption unit is a two-dimensional barcode, and the mobile device photographs the encryption unit with a camera lens to obtain an encryption signal.

5. The system for issuing and converting virtual currency in a physical voucher manner according to claim 4, wherein the application integration system further comprises a recognition unit, and the encryption signal is transmitted to the application integration system and is analytically recognized by the recognition unit to determine authenticity of the virtual currency unit.

6. The system for issuing and converting virtual currency in a physical voucher manner according to claim 1, wherein the mobile device further comprises a start unit, after the coincident signal is transmitted to the host server and is analytically compared with the pieces of virtual currency data, a start signal is generated, and then the start signal is further transmitted to the mobile device to start the start unit.

7. The system for issuing and converting virtual currency in a physical voucher manner according to claim 1, wherein the host server is connected in series to the application integration system through an application programming interface (API).

8. A method for issuing and converting virtual currency in a physical voucher manner, applied to a system, wherein the system comprises a host server, a mobile device, and an application integration system, the application integration system is connected to the host server and the mobile device, and the method comprises:
storing, by the host server, a plurality of pieces of virtual currency data;
generating a pair of public and private keys with a specific encryption algorithm;
encrypting the virtual currency data using the public key to generate encrypted data and converting the encrypted data into a quick response code;
converting the virtual currency data into a hash value using a hash function, and convert the hash value into an authentication code;
attaching the authentication code and the quick response code to a virtual currency;
receiving, by the mobile device, an authentication code input by a user; and
storing, by the application integration system, a plurality of pieces of comparison data, in which the application integration system receives the authentication code transmitted from the mobile device and generates a coincident signal after analytically comparing the authentication code with the pieces of comparison data, wherein the coincident signal is further transmitted to the host server, and is analytically compared with the pieces of virtual currency data.

9. The method for issuing and converting virtual currency in a physical voucher manner according to claim 8, wherein the virtual currency data comprises any one of a virtual currency card number, a virtual currency issuance date, and an amount of virtual currency.

10. The method for issuing and converting virtual currency in a physical voucher manner according to claim 8, wherein the authentication code is generated by a virtual currency unit, the virtual currency unit further comprises an authentication area and an encryption area, the authentication area generates the authentication code, and the encryption area generates an encryption unit.

11. The method for issuing and converting virtual currency in a physical voucher manner according to claim 10, wherein the encryption unit is a two-dimensional barcode, and the mobile device photographs the encryption unit with a camera lens to obtain an encryption signal.

12. The method for issuing and converting virtual currency in a physical voucher manner according to claim 11, wherein the application integration system further comprises a recognition unit, and the encryption signal is transmitted to the application integration system and is decrypted by the recognition unit with an encrypted signature data being decrypted with the private key to determine authenticity of the virtual currency unit.

13. The method for issuing and converting virtual currency in a physical voucher manner according to claim 8, wherein the mobile device further comprises a start unit, after the coincident signal is transmitted to the host server and is analytically compared with the pieces of virtual currency data, a start signal is generated, and then the start signal is further transmitted to the mobile device to start the start unit.

14. The method for issuing and converting virtual currency in a physical voucher manner according to claim 8, wherein the host server is connected in series to the application integration system through an application programming interface (API).
